(19) United States
(12) Patent Application Publication
(10) Pub. No.: US 2006/0106706 A1
(43) Pub. Date: May 18, 2006

(54) Apparatus and method for document processing

(76) Inventors: Joseph W. LaBonty, Phoenix, AZ (US); Timothy J. Underwood, Phoenix, AZ (US); Jennifer A. Baldwin, Gilbert, AZ (US); Matthew T. Baldwin, Gilbert, AZ (US); Gary M. Underwood, Chandler, AZ (US); Sandra L. Galaviz, Arizona City, AZ (US); Larry Salas, Mesa, AZ (US)

Correspondence Address: Mark F. Wright;Wright Law Group, PLLC, Suite 2, 7201 West Oakland, Chandler, AZ, 85226, US

(21) Appl. No.: 11/321,372

(22) Filed: Dec. 28, 2005

Related U.S. Application Data
(63) Continuation-in-part of application No. 10/802,636, filed on Mar. 16, 2004.

(51) Int. Cl. G06Q 40/00

(52) U.S. Cl. 705/35

(57) ABSTRACT

A computer-based hosted service for the standardization and implementation of holistic mortgage finance transactions is disclosed. The computer-based service allows a participant in the finance transaction to combine all required loan information for a given loan program into a single universal document library, coupled with the required forms, rules, database management tools and routines necessary to support various multiple in-process revisions and change control features for providing specific loan documents. By accessing the service, a lender can implement multiple versions of basic loan documents in various formats and manage the required changes through a controlled series of review and approval steps. In the most preferred embodiments of the present invention, the universal document library incorporates a flexible methodology for creating and simultaneously managing multiple loan document collections, thereby allowing for a virtually unlimited number of customized loan programs and documents to support the various loan programs.

### RELATED APPLICATIONS

This application is a continuation in part of U.S. patent application Ser. No. 10/802,636, filed Mar. 16, 2004, which application is now pending, which application is incorporated herein by reference.

### BACKGROUND OF THE INVENTION

1. Field of the Invention

The present invention relates generally to the real estate finance industry and more specifically relates to the use of computer systems in the population, processing and sharing/distribution of electronic mortgage-related documents.

2. Background Art

The real estate finance business is both complex and involved. The number of parties and the amount of data that must be assembled, formatted, and processed for a given mortgage transaction is formidable. Typically, for any given real estate transaction, there is at least a buyer and a seller, one or two brokers and/or agents, at least one financial institution, at least one appraiser, at least one title agency, several government agencies, at least one insurance company, and at least one lawyer. This list is neither complete nor exhaustive and, in certain situations, may include many additional individuals and/or entities. For example, in order to complete a typical mortgage loan transaction, there is often a lender, borrower, settlement agent, title company, escrow company, flood company, and investor.

Not only can the sheer number of participants in the mortgage process be daunting, the types and quantity of data utilized in completing a typical mortgage transaction can be overwhelming. Each of the previously mentioned individuals and entities has very specific, and often divergent, data requirements and needs. Some of the information that is most critical for one individual or entity is not important at all for another entity. Accordingly, the process of collecting, collating, and determining what information will fulfill the needs of the various individuals and entities and then disseminating the appropriate information to the appropriate entity or person is yet another significant task, particularly when you consider that each party or entity typically has their own requirements for data presentation (e.g., paper forms and documents, electronic presentation on computer screens, etc.). Given these disparate needs, the same data may need to be “re-keyed” or reentered by multiple entities during the course of a given transaction. Finally, the different number of forms that must be processed in a given real estate transaction can be well in excess of 50 or more and a complete package for a fairly routine real estate transaction can encompass hundreds of pages. Obviously, more complex transactions can require even more information and, correspondingly, more documents.

Given this somewhat involved background and complex environment, there is a strong desire among the participants in the real estate finance (i.e. mortgage) industry to streamline and simplify the process of gathering the requisite information, selecting and populating the necessary documents and sharing the data and documents with the other entities involved in the transaction. Accordingly, over the years, a number of steps have been taken towards this end. In the earliest stage of this simplification process, the parties involved adopted standardized paper forms and various manual procedures that, while effective, could be somewhat cumbersome.

In more recent years, the simplification effort has included the adoption of computer technology in an attempt to automate and streamline the real estate financing process. There are a number of organizations and agencies that have attempted to implement electronic versions of mortgage-related documents and to utilize e-mail, computer-based forms, and electronic data interchange for process simplification. A common point of failure for the majority of these previous simplification efforts is the fact that since the various processes were not “holistic” in nature, only a single piece of data or a single document was addressed and the overall concept of the complete real estate finance transaction was not manifest. This is largely a product of the independent nature of the various entities involved, their widely divergent needs for disparate data elements, and the relative complexity of the associated processes.

In some cases, these simplification efforts have been the result of collaboration between the various parties with a vested interest in the mortgage process. For example, the Mortgage Industry Standards Maintenance Organization (MISMO) was established by the Mortgage Bankers Association of America (MBA) to coordinate the development and maintenance of Internet-based Extensible Markup Language (XML) real estate finance specifications for data exchange transactions. The result of this effort is a series of specifications for transactions that relate to the electronic exchange of real estate financing and mortgage-related data. However, the approach taken by MISMO for exchanging real estate financing documents is also very “document centric” in that each document is a self-contained entity that is, in a sense, isolated from other, possibly related documents. In fact, current practices have led to an environment where each document is typically completely separate and independent from the other documents in the transaction. Even though the same data may appear on multiple forms, the data is typically entered into each form without regard for the use of the same data on another related form. Accordingly, as the external data related to a given document changes, each document that incorporates that revised data must also be updated to reflect the changes in the information. Additionally, the related nature of the various documents means that a change to one document may drive changes in certain associated documents.

Another problem associated with the change in data is the “ripple” effect that occurs due to the altered data in a given form. Certain data changes (i.e. down payments that affect loan-to-value ratios) may precipitate the need for additional forms. Since all necessary forms must be present in order to finalize a given real estate transaction, the isolated nature of the forms may make it very difficult to determine that additional forms are required until very late in the real estate financing process, thereby introducing unwanted and unprofitable delays. As shown by this discussion, the present approach can lead to both inefficiencies and inaccuracies in the overall mortgage process flow, either of which can be very undesirable. Specifically, any deficiencies in the documents can make the loan difficult to sell on the secondary market.

Additionally, even with the adoption of standards and guidelines for exchanging e-mortgage documents and other types of electronic or computer-based real estate finance related transactions, not all participants in the process have adopted a common or universal set of standards. In fact, the standards are constantly evolving and being adapted as technology and various industry requirements change. Accordingly, many of the existing standards that have been adopted are quickly out of date or no longer compatible with other emerging standards. This leads to the undesirable necessity of attempting to ascertain which versions of which transactions and which versions of specific data are being used by the various participants in the real estate financing process at any given time.

In addition, many of the processes and procedures used today are not true “standards” because they have been developed independently and have not been adopted throughout the entire industry. This has further exacerbated the problems already identified by creating additional requirements for translating and deciphering the various results that are produced from the disparate methodologies and technologies.

Finally, the various entities involved in a typical real estate transaction will often desire to customize and organize their mortgage-related documents based on factors such as type of property, loan program, borrower profile, lender profile, etc. For example, a given lender may implement a new loan program for first time homebuyers in order to gain a competitive advantage in the marketplace. This program will, of necessity, require the gathering of specific information that is only pertinent for first time homebuyers. Additionally, the documents needed by the lender to process the mortgage to completion may be quite different than the documents required by other loan programs offered by the lender. Accordingly, the lender will typically generate a separate set of documents and procedures for this specific program. Given that different lenders will all create and offer different programs, this further reduces the possibility of standardizing on a single set of documents for multiple parties.

While the various presently known implementations of mortgage processing methodologies are not without merit, most existing methods of implementing electronic real estate financing documents have one or more significant drawbacks, such as data dependence, data redundancy, data isolation, or the like. In these situations and with the current technology, additional opportunities for the streamlined processing of real estate financing transactions are similarly limited and lack significant potential for growth and industry adoption. Additionally, given the current limitations inherent in the existing technology, lenders are unable to create specific variations of multiple loan programs to address the ever-changing needs of borrowers in a timely fashion. Accordingly, without developing improved methods of simplifying and streamlining the implementation and exchange of electronic mortgage-related documents, the entire real estate financing process will continue to be sub-optimal for all business entities involved in the process.

### SUMMARY OF THE INVENTION

A computer-based hosted service for the standardization and implementation of holistic mortgage finance transactions is disclosed. The computer-based service allows a participant in the finance transaction to combine all required loan information for a given loan program into a single universal document library, coupled with the required forms, rules, database management tools and routines necessary to support various multiple in-process revisions and change control features for providing specific loan documents. By accessing the service, a lender can implement multiple versions of basic loan documents in various formats and manage the required changes through a controlled series of review and approval steps. In the most preferred embodiments of the present invention, the universal document library incorporates a flexible methodology for creating and simultaneously managing multiple loan document collections, thereby allowing for a virtually unlimited number of customized loan programs and documents to support the various loan programs.

### BRIEF DESCRIPTION OF THE DRAWINGS

The preferred embodiments of the present invention will hereinafter be described in conjunction with the appended wherein like designations denote like elements and:

FIG. 1 is a block diagram of a computer system for implementing a universal document library in accordance with a preferred exemplary embodiment of the present invention;

FIG. 2 is a block diagram of a data server used for implementing a universal document library in accordance with a preferred exemplary embodiment of the present invention;

FIG. 3 is a collection of related universal document libraries in accordance with a preferred exemplary embodiment of the present invention;

FIGS. 4-4C are block diagrams of a universal document library in accordance with a preferred exemplary embodiment of the present invention;

FIG. 5 is a block diagram of the tool components of a universal document library in accordance with an preferred exemplary embodiment of the present invention;

FIG. 6 is a block diagram of a method for implementing mortgage documents via universal document libraries in accordance with an preferred exemplary embodiment of the present invention;

FIG. 7 is a block diagram of various components for implementing mortgage documents via universal document libraries in accordance with an preferred exemplary embodiment of the present invention;

FIG. 8 is a block diagram of the relational elements of a process flow for implementing mortgage documents via universal document libraries in accordance with an preferred exemplary embodiment of the present invention; and

FIG. 9 is a block diagram of the process flow methodology for implementing mortgage documents via universal document libraries in accordance with an preferred exemplary embodiment of the present invention.

### DETAILED DESCRIPTION

The apparatus and methods of the present invention implement a universal document library which combines loan information into a single universal document library along with the various database management tools necessary to support various multiple in process revisions and change control features. The lender can generate various versions of its loan documents in various formats and manage the changes through a series of review and approval steps. In the most preferred embodiments of the present invention, the universal document library incorporates a flexible methodology for creating and simultaneously managing multiple loan document collections.

In the most preferred embodiments of the present invention, multiple universal document libraries are maintained by a service provider and accessed via a web portal using global computer network such as the Internet. The service provider will manage and maintain the various universal document libraries at a centralized logical location for and on behalf of various mortgage-generating agencies and/or organizations. While the universal document libraries are managed and maintained at a centralized logical location, those skilled in the art will understand that multiple physical locations can and will be utilized to provide a single centralized logical location in the most preferred embodiments of the present invention. When the end-users of the universal document libraries desire to access the universal document libraries, they can utilize the web portal from any suitably equipped computer. Additionally, in certain preferred embodiments of the present invention, the end user may store the universal document libraries in a local environment and access the universal document libraries via standard client/server interaction.

For example, when it is desired to implement a specific set of mortgage documents for a loan on a given property, the mortgage-generating agencies and/or organizations will access the service provider's web portal and the universal document libraries via a local area network, the Internet, or some other type of network. Based on the universal document library or libraries associated with a given mortgage-generating agency and/or organization, a wide variety of mortgage documents can be implemented and specifically tailored to the program requirement or needs of each mortgage-generating agency and/or organization.

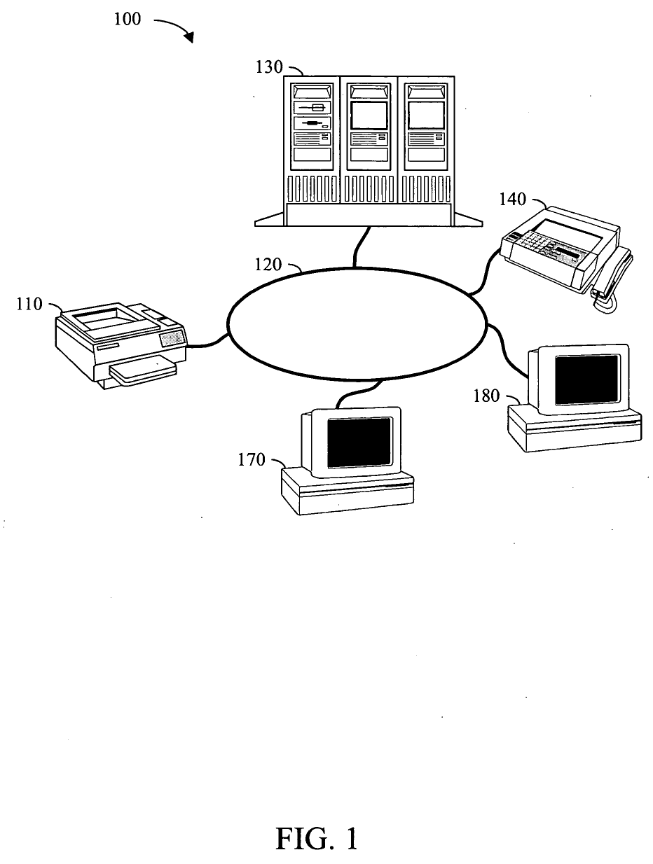

Referring now to FIG. 1, a block diagram of a computer-based system 100 for procuring, deploying, and implementing universal document libraries for mortgage loan origination and processing in accordance with a preferred embodiment of the present invention comprises: a data server 130; a computer system 170; and a computer system 180, all connected or coupled via a network 120. Additionally, an optional printer 110 and an optional fax machine 140 are shown. Taken together, the components of computer-based system 100 provide a way for financial institutions, brokers, agents, individuals, insurance providers, and the like to more efficiently and effectively manage the mortgage loan origination process using universal document libraries as described herein in conjunction with the various preferred embodiments of the present invention.

Data server 130 represents a relatively powerful computer system that is made available to computer system 170 and computer system 180 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 130 may be provided by many standard, readily available data servers. Depending on the desired size and relative power required for data server 130, storage area network (SAN) technology may also be deployed in certain preferred embodiments of the present invention. Additionally, various biometric and identification verification devices for creating and verifying digital signatures (i.e., electronic signature processing) may also be included.

Computer system 170 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as a computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, computer system 170 is linked to its own LAN or WAN and has access to its own data server (not shown this FIG.). It should also be noted that the use of XML and Extensible Stylesheet Language (XSL) allows the methods of the present invention to be platform independent, something that has not been achieved prior to the disclosure of the present invention.

Similarly, computer system 180 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as a computer system 180. It should be noted that no specific operating system or hardware platform is excluded and it is anticipated that many different hardware and software platforms may be configured to create computer system 180. As previously explained in conjunction with data server 130, various hardware and software components (not shown this FIG.) known to those skilled in the art may be used in conjunction with computer system 180. It should also be noted that in the most preferred embodiments of the present invention, computer system 180 is linked to its own LAN or WAN and has access to its own data server (not shown this FIG.).

Network 120 is any suitable computer communication link or communication mechanism, including a hardwired connection, an internal or external bus, a connection for telephone access via a modem, DSL, or high-speed T1 line, radio, infrared or other wireless communication methodologies, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, network 120 represents and comprises a standard Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to procure and deploy mortgage-related documents via the implementation of universal document libraries as described in conjunction with the preferred embodiments of the present invention. Regardless of physical nature and topology, network 120 serves to logically link the physical components of computer-based system 100 together, regardless of their physical proximity. This is especially important because in many preferred embodiments of the present invention, data server 130, computer system 170, and computer system 180 will be geographically remote and separated from each other.

In general, data server 130 processes requests for various transactions from computer system 170 and computer system 180. A typical transaction may be represented by a request for implementing a new mortgage loan program for one or more kinds of mortgage transactions, discontinuing an existing loan program, or updating or modifying an existing mortgage loan program. In this case, a request to access a universal document library or a mortgage loan program associated with a universal document library is sent from computer system 170 or computer system 180 to data server 130. Data server 130 processes the request and takes the specific action requested by computer system 170 or computer system 180. The request may be directed towards the creation or modification of an existing mortgage loan program, the creation or modification of an existing universal document library, or other similar requests.

It should be noted that while FIG. 1 shows only a single computer system 170 and a single computer system 180, it is anticipated that the most preferred embodiments of the present invention will comprise hundreds and even thousands of computer systems 170 and computer systems 180. Each of these computer systems 170 and 180 will be configured to access data server 130 in an appropriately secure way so as to accomplish the specific objectives of the user of the computer system 170 or computer system 180. For example, the service provider that controls the universal document libraries may utilize computer system 170 or computer system 180 to access data server 130 and create or modify a universal document library. A loan originator may use computer system 170 or computer system 180 to access data server 130 to implement a new mortgage loan program that has been implemented and deployed via the use of universal document libraries, etc.

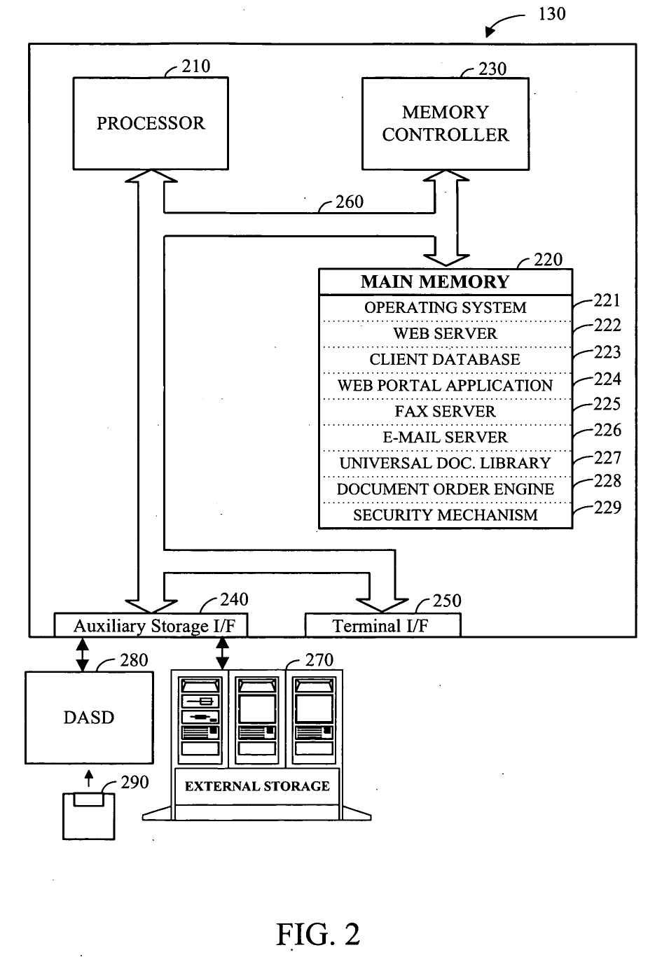

In the most preferred embodiments of the present invention, multiple computer systems 170 and multiple computer systems 180 will all be configured to communicate with data server 130 and with each other via network 120. In addition, the most preferred embodiments of the present invention include an Application Service Provider (ASP) environment where data server 130 is operated as a clearinghouse in a hosted operation. In this fashion, multiple computer systems 170 and computer systems 180 will have access to data server 130 and the associated universal document libraries on a subscription or pay-for service basis. Data server 130 is further described below in conjunction with FIG. 2 below.

Optional printer 110 and an optional fax machine 140 are standard peripheral devices that may be used for transmitting or outputting paper-based mortgage documents, notes, financial transactions, reports, etc. in conjunction with the mortgage loan programs processed by computer-based system 100. Optional printer 110 and an optional fax machine 140 may be directly connected to network 120 or indirectly connected to network 120 via any or all of computer systems 170, computer systems 180, and/or data server 130. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Referring now to FIG. 2, a data server 130 in accordance with a preferred embodiment of the present invention is a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the salient features of data server 130.

Processor 210 performs computation and control functions of data server 130, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a floppy disk drive that may read programs and data from a floppy disk 290. It is important to note that while the present invention has been (and will continue to be) described in the context of a fully functional computer system, those skilled in the art will appreciate that the various software mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as floppy disks (e.g., disk 290) and CD ROMS, and transmission type media such as digital and analog communication links, including wireless communication links.

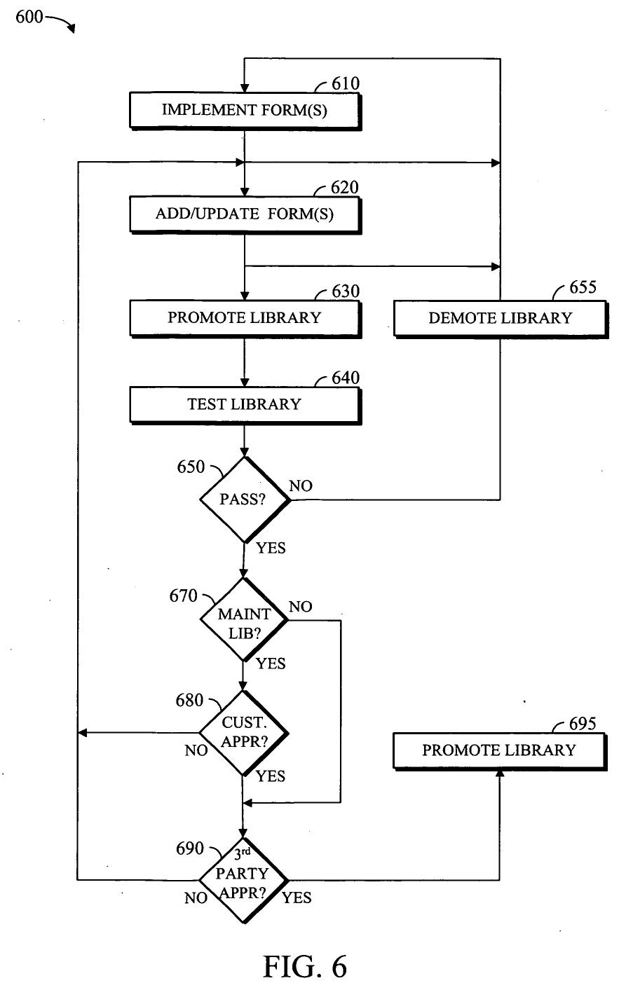

In the most preferred embodiments of the present invention, various preferred embodiments of the program product may be configured to: create and modify universal document libraries; configure and implement various documents for a multitude of loan programs based on universal document libraries; identify the user of a given universal document library and the mortgage loan programs associated with that user; procure an appropriate mortgage loan package for a given user using a universal document library; and use XML and/or XSL to implement, update and transmit mortgage loan information associated with or derived from one or more universal document libraries. In this fashion, the appropriate entities (i.e., brokers, lender, title companies, insurance companies, etc.) can utilize the program product to initiate and complete a wide variety of real estate finance transactions. Similarly, a program product in accordance with one or more preferred embodiments of the present invention can also be configured to perform substantially all of the steps depicted and described in conjunction with FIG. 6 below for a specific universal document library and other similar transactions well known to those skilled in the art.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, a client database 223, a web portal application 224, a fax server 225, an e-mail server 226, a universal document library 227, a document order engine 228 and a security mechanism 229. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although universal document library 227 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web portal application 224. Additionally, security mechanism 229 may also provide encryption capabilities for computer-based system 100 of FIG. 1, thereby enhancing the robustness of computer-based system 100. Once again, depending on the type and quantity of information stored in client database 223 and universal document library 227, security mechanism 229 may provide different levels of security and/or encryption for different computer systems 170 and 180 of FIG. 1. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with web portal application 224, including via network 120 of FIG. 1.

Client database 223 is representative of any suitable database known to those skilled in the art. In the most preferred embodiments of the present invention, client database 223 is a Structured Query Language (SQL) compatible database file capable of storing information relative to the various entities that may utilize computer-based system 100 of FIG. 1 to devise and implement mortgage loan programs and real estate financing transactions, including names, addresses, account preferences, etc. for the various end-users and their clients. While client database 223 is shown to be residing in main memory 220, it should be noted that client database 223 may also be physically stored in a location other than main memory 220. For example, client database 223 may be stored on external storage device 270 or DASD 280 and coupled to data server 130 via auxiliary storage I/F 240.

Web portal application 224 is most preferably a software application configured to coordinate and manage the creation and implementation of various mortgage loan programs using universal document libraries within computer-based system 100 of FIG. 1. Specifically, web portal application 224 is configured to process requests from the various entities that create and manage universal document libraries as well as the various entities that create and manage mortgage loan applications and transactions. Web portal application 224 also works in conjunction with universal document library 227 to perform rules processing activities for assembling various documents that are provided in response to end-user requests. As previously explained, the most preferred embodiments of the present invention utilize XML for the document file format.

Fax server 225 is any fax server known to those skilled in the art and is configured to receive inbound fax messages and to transmit outbound fax messages. Fax server 225 may format and transmit any data processed by computer-based system 100 of FIG. 1 and make it available for use by any other component of computer-based system 100 of FIG. 1. Additionally, fax server 225 may process the data received and send it directly to web portal application 224 and make the incoming data for further processing by computer-based system 100, including processing universal document library 227 and by web portal application 224.

While not required, the most preferred embodiments of data server 130 of FIG. 1 will typically include an e-mail server 226. E-mail server 226 is any e-mail server application capable of being configured and used to send and receive various status messages and updates to data server 130 and between computer systems 170 or 180 of FIG. 1 via e-mail, as may be necessary to enhance the overall process of completing various real estate financing transactions described herein. This includes the generation of automated e-mail messages relating to the order process and management of real estate mortgage transactions performed in accordance with the various preferred embodiments of the present invention. Automated e-mail messages are also generated to provide notifications regarding the creation, management, and deployment of universal document libraries in accordance with the preferred embodiments of the present invention. Document order engine 228 is a software mechanism that can, in conjunction with user input, be employed to parse and procure mortgage-related documents using universal document library 227. While document order engine 228 may be a stand-alone application, in at least some preferred embodiments of the present invention, document order engine 228 may be incorporated into web portal application 224.

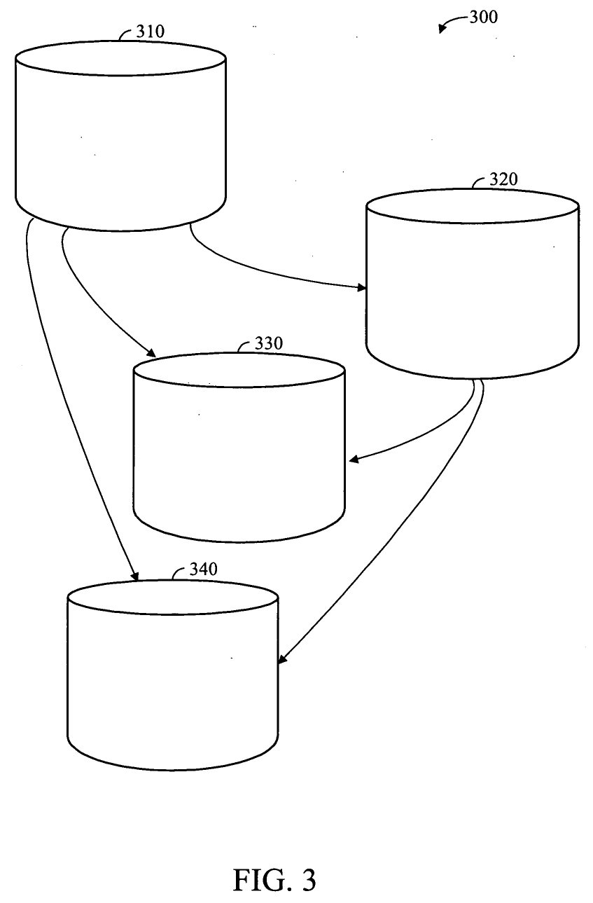

Referring now to FIG. 3, a collection of related universal document libraries, namely a universal compliance library 310, a universal standard library 320, a universal maintained library 330, and a universal custom library 340 in accordance with a preferred embodiment of the present invention are depicted. While closely related, each of these universal document libraries is typically somewhat different as to purpose, content, and properties.

Specifically, universal compliance library 310 is a fairly generic master library that contains all forms, packages, tools, etc. necessary to implement various loan documents for a wide variety of loan programs. In the most preferred embodiments of the present invention, selected portions of universal compliance library 310 may be used to implement other universal document libraries that are directed towards the specific needs of any given loan originator and/or loan program. Universal compliance library 310 is most preferably managed by a third party service provider and serves as a source of master documents for implementation in one or more linked universal standard libraries 320, universal maintained libraries 330, and universal custom libraries 340. In this fashion, universal compliance library 310 serves as a reference document library and does not serve as a transactional database. Whenever a form and/or document within universal compliance library 310 is updated, then corresponding updates are made to the corresponding linked forms and/or documents in any universal standard library 320, universal maintained library 330, and/or universal custom library 340.

Universal standard library 320 is a universal document library of forms that contains links to certain forms contained in universal compliance library 310. Consequently, universal standard library 320 contains a subset of the forms and packages contained in universal compliance library 310. In this fashion, universal standard library 320 and may be used in a transactional environment to implement selected loan programs by different loan providers.

Universal maintained library 330 is a customer specific universal document library, based on universal compliance library 310 or universal standard library 320 that is maintained by a third party service provider for and on behalf of a mortgage loan provider. As with the other universal document libraries, universal maintained library 330 is a universal document library of forms that contains links to certain forms contained in universal compliance library 310 or universal standard library 320. Consequently, universal maintained library 330 contains a subset of the forms and packages contained in universal compliance library 310 or universal standard library 320. In this fashion, universal maintained library 330 may be updated by the third party service provider and the resulting loan packages may be used in a transactional environment to implement selected loan programs by different loan providers.

Universal custom library 340 is a customer specific universal document library, based on universal compliance library 310 or universal standard library 320 that is not maintained by a third party service provider. Instead, the loan program provider will maintain universal custom library 340 themselves. As with the other universal document libraries, universal custom library 340 is a universal document library of forms that contains links to certain forms contained in universal compliance library 310 or universal standard library 320. Consequently, universal custom library 340 contains a subset of the forms and packages contained in universal compliance library 310 or universal standard library 320. In this fashion, universal custom library 340 may be updated by the loan program provider and the resulting loan packages may be used in a transactional environment to implement selected loan programs according to the business needs of the loan program provider.

Additionally, it should be noted that while a single universal compliance library 310, universal standard library 320, universal maintained library 330, and universal custom library 340 are shown in FIG. 3, those skilled in the art will recognize that most preferred embodiments of the present invention may include multiple instances of each of these universal document libraries. For example, with multiple lending agencies, multiple universal maintained libraries 330 may be deployed, with each universal maintained library 330 being developed and maintained to support specific lenders and/or specific lender programs. It should be noted that universal custom library 340 and universal maintained library 330 contain only the documents and rules that vary from the documents and rules associated with standard library 320 and universal compliance library 310. Each universal custom library 340 and universal maintained library 330 “inherits” the documents and rules associated with the parent library to which they are linked, as explained below. Those skilled in the art will recognize that the enumerated libraries set forth herein are merely examples of the many types of libraries that may be deployed in the various preferred embodiments of the present invention. For example, a “universal deployed library” may be created and linked to a universal standard library 320 and deployed at a given customer location.

Finally, as shown in FIG. 3, universal standard library 320, universal maintained library 330, and universal custom library 340 may be linked to universal compliance library 310 or, alternatively, universal maintained library 330, and universal custom library 340 may be linked to universal standard library 320, which is in turn linked to universal compliance library 310. This process allows for the “inheritance” of certain features and functions associated with the specific rules and documents used in implementing a real estate financing transaction. In this fashion, updates to universal compliance library 310 can “trickle down” to any linked universal standard library. Similarly, any change to a universal standard library can “trickle down” to any linked universal maintained library 330 and/or universal custom library 340. In general, for a universal custom library 340, either the lender or a third party would be responsible for initiating and/or approving changes to the documents and/or rules associated with the library. For a universal maintained library, 330 the initiation and approval of changes will be handled by a third party.

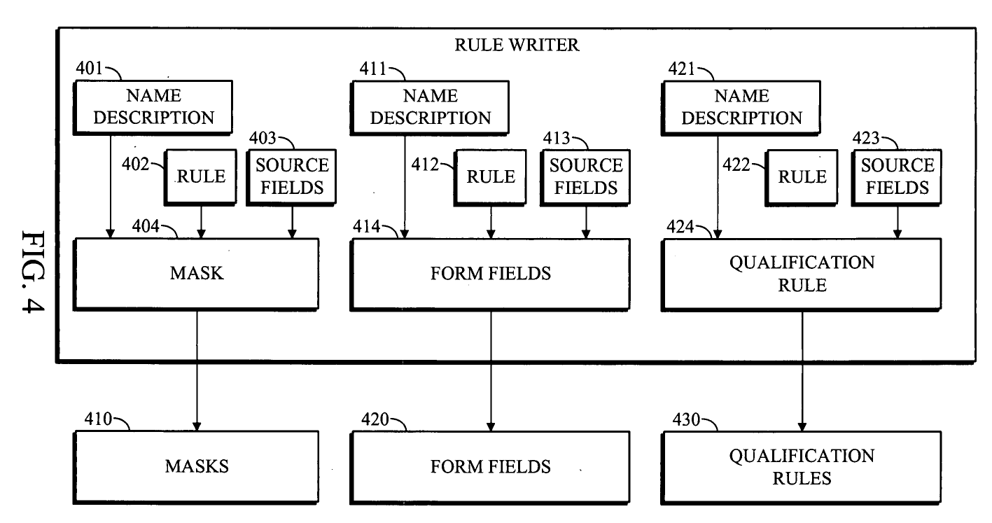

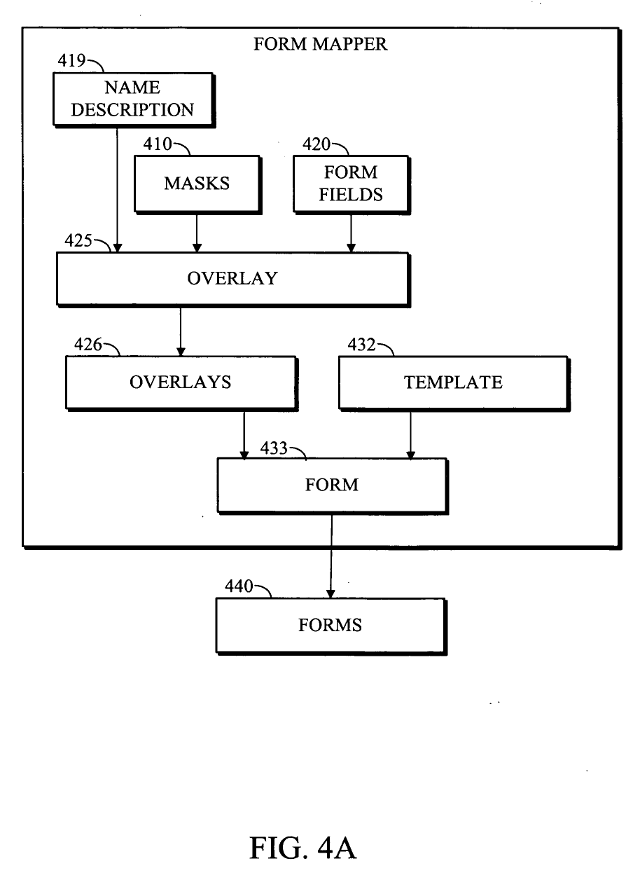

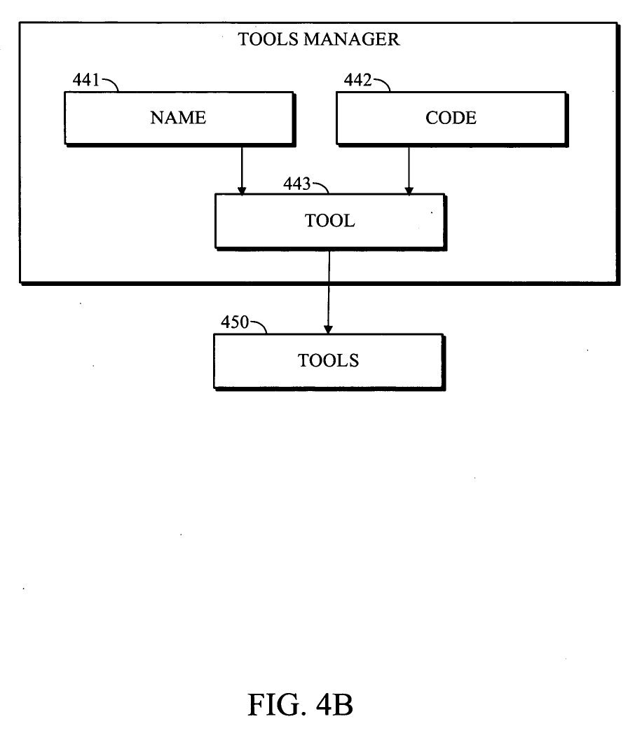

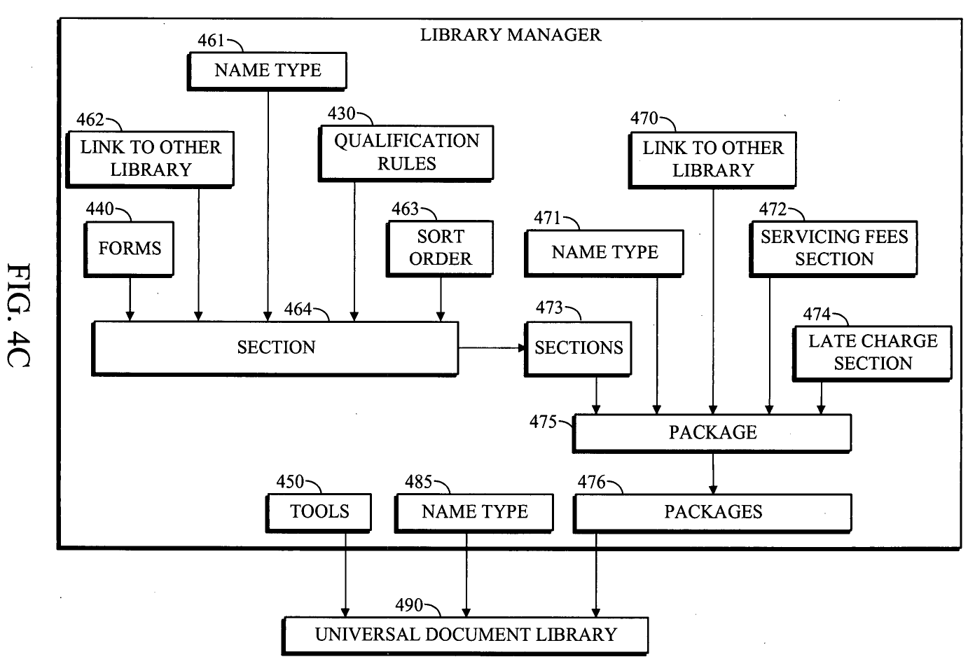

Referring now to FIGS. 4, 4A, 4B, and 4C a universal document library 490 in accordance with a preferred exemplary embodiment is depicted. As shown in FIG. 4, a Rule Writer is configured to include at least one type of rule and most preferably three different types of rules into a universal document library 490. Examples of the type of rules created using a Rule Writer are masks 410, form fields 420, and qualification rules 430. Masks are used as templates to determine how to format the data on a given form. For example, a mask 403 may be implemented to control the output of a date on a form so that the date is displayed on the form in the format January, 15^{th}, 2006 instead of 01/15/2006. Form Fields 414 are used for determining how to populate data on the form. For example, the name of the borrower on the loan is identified in a Form Field and the data from the database for the borrower name will be extracted from the database and placed on the form at the location where indicated by the associated Form Field for the borrower name. Qualification Rules 424 are rules associated with a given form and implemented to determine if the form should be included in a selected loan package based upon the loan data. For example, it is generally only appropriate to include a “prepayment penalty rider form” in a selected loan package generated from a universal document library when the prepayment penalty is greater than zero. By utilizing an appropriately configured qualification rule, if no prepayment penalty is assessed for a particular loan program then no prepayment penalty rider form will be included in the document set for that particular loan program.

An individual mask 404 is constructed with a name and a description 401 that name and describe the type of mask (i.e., date mask) and a source field 403 that are combined with a programmatic rule 402 that is used to execute the rule against the appropriate form where the rule resides. Each form in a universal document library may comprise a collection of individual masks 404, with the collection of masks 404 being designated as masks 410 in FIG. 4. An individual form field 414 is constructed using a name description 411 to describe the form field (i.e., customer name), a programmatic rule 412 that is used to execute the rule, and one or more source fields 413. Each form in a universal document library may comprise a collection of form fields 414, with the collection of form fields 414 being designated as form fields 420 in FIG. 4. Similarly, an individual qualification rule 424 is constructed using a name description 421 to describe the qualification rule (i.e., late charge form), a programmatic rule 422 that is used to execute the rule, and one or more source fields 423. Each form in a universal document library may comprise a collection of qualification rules 424, with the collection of qualification rules 424 being designated as qualification rules 430 in FIG. 4.

Referring now to FIG. 4A, a Form Mapper tool in accordance with a preferred embodiment of the present invention includes the collection of masks 410 and form fields 420, along with a name description 419 to implement an overlay 425. Each form 433 in a universal document library will have one or more overlays 426 that specify how the data will appear on the page. By using multiple overlays 426, a single template 432 can be adapted for use with multiple different lenders without the necessity of creating a new template each time. When used in conjunction with a template 432, the appearance and location of the data on the page can be controlled. Since most loan packages will comprise a number of different forms, a collection of forms 440 can be assembled for inclusion in a universal document library.

Referring now to FIG. 4B, a Tool Manager can be used to configure one or more tools for inclusion in a universal document library. Each tool 443 will typically have a name 441 and associated code 442. A collection of tools 450 may also be assembled for inclusion in a universal document library.

Referring now to FIG. 4C, a library manager for implementing one or more universal document libraries 490 is depicted. As shown in FIG. 4C, a universal document library 490 suitably includes one or more packages 475 and may include a collection of packages 476. Additionally, one or more tools 450 may be included as well as a name type 485 that identifies the universal document library.

Each package 475 suitably comprises one or more sections 473, a late charge section 474, a servicing fees section 472, a link to one or more other libraries 470, and a name type 471. These various sections, associated with package 475, are illustrative of the various sections that may be included. Those skilled in the art will recognize that other section may also be included, depending on the specific application.

Each section 473 suitably comprises one or more section 464, a sort order 463, one or more qualification rules 430, a link to one or more other libraries 462, one or more form collections 440 and a name type 461.

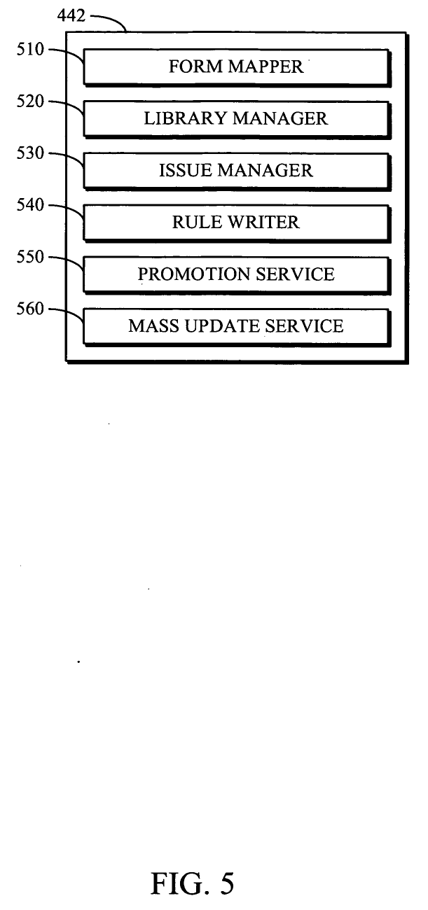

Referring now to FIG. 5, a block diagram of various tools 500 for use in implementing mortgage documents and loan programs in conjunction with universal document libraries in accordance with a preferred embodiment of the present invention is depicted. As shown in FIG. 5, tools 500 include: a Form Mapper 510; a Library Manager 520; an Issue Manager 530; a Rule Writer 540; a Promotion Service 550; and a Mass Update Service 560.

Form Mapper 510 is a what-you-see-is-what-you-get “WYSIWYG” software application for mapping form fields to a specific form. By utilizing a set of templates or “form families,” the user can quickly and easily implement the set of forms necessary for adopting a desired loan program. Different mortgage lenders will use different form families and implement different types of forms, depending on the specific needs and requirements of their programs.

Library Manager 520 is a web application that packages groups of forms into universal document libraries, including all necessary packages, rules, etc. that may be necessary for a mortgage originator to implement their desired mortgage program or programs.

Issue Manager 530 provides a mechanism for tracking change requests across the different tools that are included in a universal document library. Issue Manager 530 includes database identification information and tracks the changes in the forms associated with Form Mapper 510 and Library Manager 520. Each “issue” represents a change request that needs to be made to a given universal document library. Examples of changes that may be necessary are the result of compliance updates (e.g. laws change), lender updates to begin or end new loan products, etc. Any change can affect many different rules, forms, packages etc.

Issue Manager 530 provides a single place to document and track a given Issue. Documentation for a given issue generally consists of an identifier (alpha-numeric nick-name for the issue), a name for the request, a description of the request, and the name of the customer requesting the change. Those skilled in the art will recognize that this schema may be expanded to include billing/invoicing information, estimates for the amount of work required for the request, sign-off tracking, time/cost tracking, etc. Issues created in Issue Manager 530 can then be attached to the changes made in the other tools (i.e., Rule Writer 540, Form Mapper 510, Library Manager 520).

For example, when a form is updated with the new text to meet the new legal requirements, the new version of the form will be associated with the issue (in the Form Mapper SQL database typically by the use of a foreign key). When the package that includes that form is updated in Library Manager, the change made in library manager would also be associated with the same issue. In order to successfully identify or deploy the changes to production, a user could then run a simple query/report to find all of the changes made for the issue, which in our example would return both the change made in Form Mapper and Library Manager. This has the benefit of making it easy to identify, track and deploy the many and disparate changes that are required to create accurate universal document libraries.

Rule Writer 540 is a tool that is included in a universal document library tool collection and is used throughout the process to create, track, update, and maintain the rules that are used in conjunction with various document packages and document collections. The rules accessed and used in conjunction with Rule Writer 540 are included with each universal document library and indicate to the document order engine how to populate the documents, present the data on the form, which forms to include, etc.

Rule Writer 540 is a programmatic tool for creating the rules that will be used by the document order engine when procuring document collections from a universal document library. Rule Writer 540 provides a GUI that isolates business users from the coding and programming required to create a rule by allowing the user to simply use standard windows type interfaces to create rules. For example a form field rule might be used to populate the name field as “last name, first name”. Rule Writer 540 would allow the user to select the Last Name field, press an add button, select the text “,” (comma and a space) and then press the add button again and select the first name field.

Examples of the type of rules created using Rule Writer 540 are masks, form fields, and qualification rules. Masks are used as templates to determine how to format the data on a given form. For example, a mask may be implemented to control the output of a date on a form so that the date is displayed on the form in the format January, 15^{th}, 2006 instead of 01/15/2006. Form Fields are used for determining how to populate data on the form. For example, the name of the borrower on the loan. Qualification rules are implemented to determine if a given form should be included in a selected loan package based upon the loan data. For example, it is generally only appropriate to include a “prepayment penalty rider form” in a selected loan package generated from a universal document library when the prepayment penalty is greater than zero. By utilizing an appropriately configured qualification rule, if no prepayment penalty is assessed for a particular loan program then no prepayment penalty rider form will be included.

The most preferred embodiments of Rule Writer 540 also include a variety of standard change management features that can be shared by other tools associated with a given universal document library. This includes features such as version control, check-in/check-out procedures, etc. Those skilled in the art will recognize that these features are valuable to allow for multi-user access and control functionality of a data store.

Promotion Service 550 is a software application that can be utilized to “promote” a universal document library from one deployment environment to another. For example, at inception, a new loan or mortgage program will be initiated in a development environment. Once development has been completed, the universal document library may be promoted to the testing environment to verify the accuracy and sufficiency of the documents made available from the universal document library. Once testing has been completed, the universal document library can be promoted to the production environment and utilized by the end user to implement various loan programs. If a universal document library fails the testing process, Promotion Service 550 can be used to “demote” the universal document library back to the development environment where the necessary changes can be implemented. In the most preferred embodiments of the present invention, changes are made to the universal compliance library and then promulgated to other linked libraries automatically.

Mass Update Service 560 is a software application that serves to update one or more forms in one or more universal document libraries due to updates or changes in a loan program. In conjunction with Promotion Service 550, the user can update the rules, forms, etc. in a master universal document library and the changes can then be quickly and easily promulgated to any and all linked libraries, based on the selections made by the user. When invoked, Mass Update Service 560 will replicate the desired changes in the affected forms for the selected loan packages, thereby ensuring accuracy and completeness in the resultant loan documents when completed. This function is particularly useful for updates to the various loan documents in a universal document library when changes are necessitated due to regulatory rules and requirements. Additionally, for universal custom libraries and universal managed libraries that are linked to standard universal document libraries, the changes invoked by Mass Update Service 560 will “ripple” through from the standard document library.

Referring now to FIG. 6, a method 600 for implementing mortgage documents via universal document libraries in accordance with a preferred embodiment of the present invention is depicted. As previously explained, the most preferred embodiments of the present invention will include one or more universal document libraries implemented and hosted using a third party Application Service Provider (ASP) hosted model with the components being deployed over a computer-based network. Depending on the security model employed, various lenders and other participants in the mortgage loan process will be able to access the ASP web site and participate in method 600. Other embodiments may use a more traditional client/server architecture for deployment of the various universal document libraries.

As shown in FIG. 6, the implementation of a given loan program, with the accompanying loan package, begins with the process of implementing at least one form used in offering a loan in a mortgage program (step 610). The implementation of a form includes the process of incorporating within the form the various fields and rules used to populate the form so that the necessary information is included in the proper location on the form. This process is most preferably accomplished using Form Mapper 510 previously described in conjunction with FIG. 5.

Once the form or forms have been initially implemented, the form(s) can be included in the appropriate library (step 620). This library may be a universal compliance library 310, containing all of the necessary data and tools for implementing a wide variety of mortgage programs. Alternatively, the form(s) may be added to a universal standard library 320, a universal maintained library 330, and a universal custom library 340, depending on the specific mortgage loan program and the needs of the company implementing the loan program. In some cases, instead of adding a new form, an existing form in an existing universal document library may require updating (step 620). In this case, an issue will be identified, the existing form will be updated and, by using the mass update feature of the present invention, any form(s) in any other libraries that are linked to the updated form(s) are also updated. As previously explained, the forms, sections, and packages associated with the form(s) are arranged as part of the universal document library during this process.

As shown in FIG. 6, the process of implementing, adding and/or updating forms for any type of universal document library can be continued as long as necessary to complete the desired loan packages for inclusion in the universal document library. Once the universal document library has been completed, it can be promoted for testing (step 630). The testing process will typically reflect the intended use and include the intended audience. In most cases, the testing procedure will include using the universal document library to procure a plurality of mortgage related documents and then verifying the accuracy of both the number and type of said plurality of documents as well as the contents of said plurality of documents. In the case of a universal compliance library 310, the third party host may perform its own testing process to validate the accuracy and completeness of the forms and packages contained in the universal compliance library 310. This testing process may or may not include potential users of an ASP hosted service that is implemented to deploy the universal document libraries and associated forms in accordance with a preferred embodiment of the present invention. Those skilled in the art will recognize that this example is an illustration of one possible scenario and this specific example is not meant to be limiting or exhaustive.

In the case of a universal standard library 320, a universal maintained library 330, and/or a universal custom library 340, the testing process (step 640) will most preferably include the ultimate end-user of the loan packages being implemented in each respective library. This is particularly true in the case of a universal maintained library 330 where the universal document library is being explicitly managed for and on behalf of a specific customer or other business entity.

In certain applications, it may be appropriate for the testing process for a universal custom library 340 to be conducted completely by the ultimate end-user since they will eventually be responsible for making any necessary changes and/or updates to the universal custom library 340. This is the case for a universal custom library 340.

Regardless of the nature of the specific universal document library being tested, the protocol will involve the rigorous examination of the resultant loan documents derived from the universal document library. During the testing process, the resultant loan documents will be evaluated against the desired acceptance criteria and either pass or fail the testing protocol (step 650). If the resultant loan documents are not acceptable (step 650=“NO”), then the universal document library will be demoted from testing environment (step 655) and updated by programming, adding and/or updating form(s) and their associated rules (step 620). This process will continue until the resultant documents pass the testing protocol (step 650=“YES”).

Once the resultant documents pass the testing protocol (step 650=“YES”), the universal document library may be involved in various approvals steps (steps 670, 680, and 690). In the case of a universal maintained library 330, the approval of the customer or other business entity will typically be necessary. Once customer approval is obtained (step 680=“YES”), then further approval from a third party may be required (step 690).

If this third party approval process is utilized, the universal document library will be continually tested until it receives the approval of the third party (step 690=“YES”). At that time, the universal document library can be promoted for use by its intended audience (step 695). The third party approval process is representative of approval from any third party not directly involved in the creation or maintenance of the universal document library. This may include legal counsel for the end-user of the universal document library, a regulatory agency, an investment group, etc. In each approval process step, if approval is not obtained, then additional modifications or additions may be required (step 620).

Regardless of which approval processes are required, upon successful testing and approval, the universal document library is ready for deployment (step 695). Once deployed, the universal document library serves as the basis for ordering and implementing one or more real estate financing transactions.

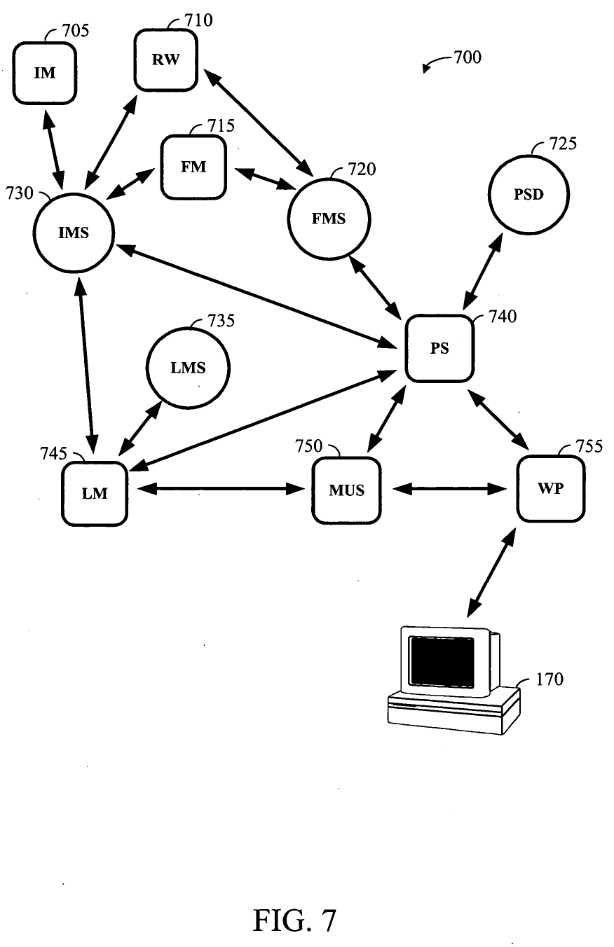

Referring now to FIG. 7, a block diagram 700 of various interconnected components for implementing mortgage documents via universal document libraries in accordance with a preferred exemplary embodiment of the present invention is depicted. The interconnected components of block diagram 700 represent various computerized tools and databases for implementing one or more universal document libraries in accordance with a preferred embodiment of the present invention. As shown in FIG. 7, the various components are configured to communicate directly and indirectly with the other components to create and manage one or more universal document libraries.

As shown in FIG. 7, a user of computer system 170 of FIG. 1 can access the interconnected components of block diagram 700 via a web portal 755. Web portal application 755 is similar to web portal application 224 of FIG. 2 and is most preferably configured to offer a web-based user interface to the interconnected components and is accessed via any type of standard web browser. Web server 222 of FIG. 2 may be used to create and operate web portal 755. By accessing web portal application 755 via a web-based user interface, a user may access, update, and modify one or more universal document libraries. Specifically, web portal application 755 provides users with the communication capability necessary to access Promotion Service 740 to promote and/or demote rules, forms and universal document libraries. Similarly, a user may utilize Web Portal Application 755 to initiate mass updates via Mass Update Service 750.

As previously explained in conjunction with FIG. 5, Issue Manager (IM) 705 is a tool or a mechanism for tracking change requests (“issues”) across the different tools that are included in a given universal document library. Issue Manager 705 is configured to access and communicate with Issue Manager Database 730.

Issue Manager Database (IMS) 730 is a database that has been configured to store the various issues or change requests that are being processed by Issue Manager 705.

As previously explained in conjunction with FIG. 5, Rule Writer (RW) 710 is a tool that is included in a universal document library and that is used throughout the process to create, track, update, and maintain the rules that are used in conjunction with various document packages and document collections. Rule Writer 710 is configured to access and communicate with Issue Manager Database 730. The rules associated with Rule Writer 710 are stored in Form Mapper Database 720. Rule Writer 710 will access Issue Manager database 730 to select an issue when updating or adding a rule to apply to the rule.

As previously explained in conjunction with FIG. 5, Form Mapper (FM) 715 is a what-you-see-is-what-you-get “WYSIWYG” software application or tool for mapping form fields to a specific form. Form Mapper 715 will access Issue Manager Database 730 to select a given issue when updating or adding a form to apply to the version of the form.

Form Mapper Database (FMS) 720 is a database configured for storing forms, form fields, and various rules being tracked and or processed by Rule Writer 710 and Form Mapper 715. Form Mapper 715 also stores the version history for the various forms and rules used in universal document libraries in Form Mapper Database 720.

As previously explained in conjunction with FIG. 5, Library Manager (LM) 745 is most preferably a web application that packages groups of forms into universal document libraries, including all necessary packages, rules, etc. that may be necessary for a mortgage originator to implement their desired mortgage program or programs. Library Manager 745 accesses Issue Manager Database 730 to select a given issue when updating or adding a universal document library, thereby apply the given issue to the appropriate version of the universal document library.

As previously explained in conjunction with FIG. 5, Library Manager Database (LMS) 735 is a database used by Library Manager 745 for storing data used in the editing of loan packages and libraries. Additionally, Library Manager 745 saves version in Library Manager Database 735.

As previously explained in conjunction with FIG. 5, Promotion Service (PS) 740 is a software application that allows a user to manually “promote” a universal document library from one deployment environment to another. Promotion Service 740 accesses Library Manager 745 to promote universal document libraries. Since Library Manager 745 is a web service like Promotion Service 740 Promotion Service 740 utilizes Library Manager 745 as a helper service, thereby obviating the need to program multiple database access routines. Additionally, Promotion Service 740 writes a history of all promotions and/or demotions to Promotion Service Database 725.

As previously explained in conjunction with FIG. 5, Promotion Service Database (PSD) 725 used for tracking the status and the promotion and/or demotion activity of a given universal document library throughout the development and deployment process. Promotion Service 740 will access the Form Mapper Database 720 to promote the appropriate forms and rules in conjunction with the promotion or demotion of a given universal document library. Promotion Service 740 will also access Issue Manager Database 730 to mark Issues that have been completed as well as to promote all of the changes related to a given Issue.

As previously explained in conjunction with FIG. 5, Mass Update Service (MUS) 750 is most preferably a software application that serves to update one or more forms in one or more universal document libraries due to updates or changes in a loan or mortgage program. Mass Update Service 750 is configured to communicate with Library Manger 745 to apply mass updates to any and all affected universal document libraries. Additionally, Mass Update Service 750 is configured to communicate with Promotion Service 740 to apply the same changes and promotion activity many times, to include any and all universal document libraries that contain forms that have been affected by a change.

Using the interconnected components described in FIG. 7, a simple example can be used to demonstrate the operability of the components. In this example, the user has determined that it will be necessary to update a Form Field Rule for the borrower's name on all forms where the borrower's name appears so as to include the middle initial of the borrower. Previously, the various forms only displayed the first and last name of the borrower but now the lenders are demanding that the middle initial of the borrower also be included. This means that the Form Field Rule will need to be updated to collect and display last name, first name, and middle initial (i.e., Smith, Frank R.).

To accomplish this change, a user will use computer system 170 to access Promotion Service 740 via Web Portal Application 755. The user will activate Web Portal Application 755 to initiate a change request (Issue) by adding the change request to Issue Manager Database 730. While some components have been described as web-based applications or client/server applications, those skilled in the art will recognize that these distinctions are made based upon a one specific embodiment and that other choices may be made for other application environments. For example, a tool that is described herein as a client/server tool may be deployed as an internet or web-based tool and vice-versa. Similarly, any web portal application may be deployed as a client/server application if security and/or bandwidth considerations so dictate.

Issue Manager 705, being alerted to a change to Issue Manager Database 730, will activate Rule Writer 710. Rule Writer 710 will check out the appropriate rule from Form Mapper Database 720 and mark the rule for “testing” status, make the appropriate change to the rule, and check the rule back into Form Mapper Database 720 where it can be associated with the appropriate Form Fields and forms that incorporate that Form Field.

The user can then utilize Web Portal Application 755 to test the updated rule to ensure that the operation of the rule is as desired. Once the rule has been tested to ensure accuracy by the user, the user can invoke Promotion Service 740 to promote the updated Form Field to “production” status. Next, Web Portal Application 755 will be used to invoke Mass Update Service 750 to apply the new version of the form field to all forms containing that specific updated form field.

Mass Update Service 750 will invoke Promotion Service 740 to create a new version for each affected form, thereby incorporating the new Form Field version and associating the new form or forms with the issue and marking the form status as “testing.” The user can then use Web Application Portal 755 to test the behavior of the updated forms to ensure success. After testing the new forms to ensure that they are accurate, the user can promote the updated forms to “production” status.

Once the form has been returned to “production” status, the user can once again use Web Application Portal 755 to invoke Mass Update Service 750 to make a new library version for each universal document library that utilized the updated form and mark the status of each affected universal document library as “testing.” Then the user can utilize Web Application Portal 755 to test the new version of the affected universal document libraries. After testing and approving the updated universal document library versions, the user can once again access Promotion Service 740 via Web Application Portal 755 to promote the updated universal document libraries to “production” status.

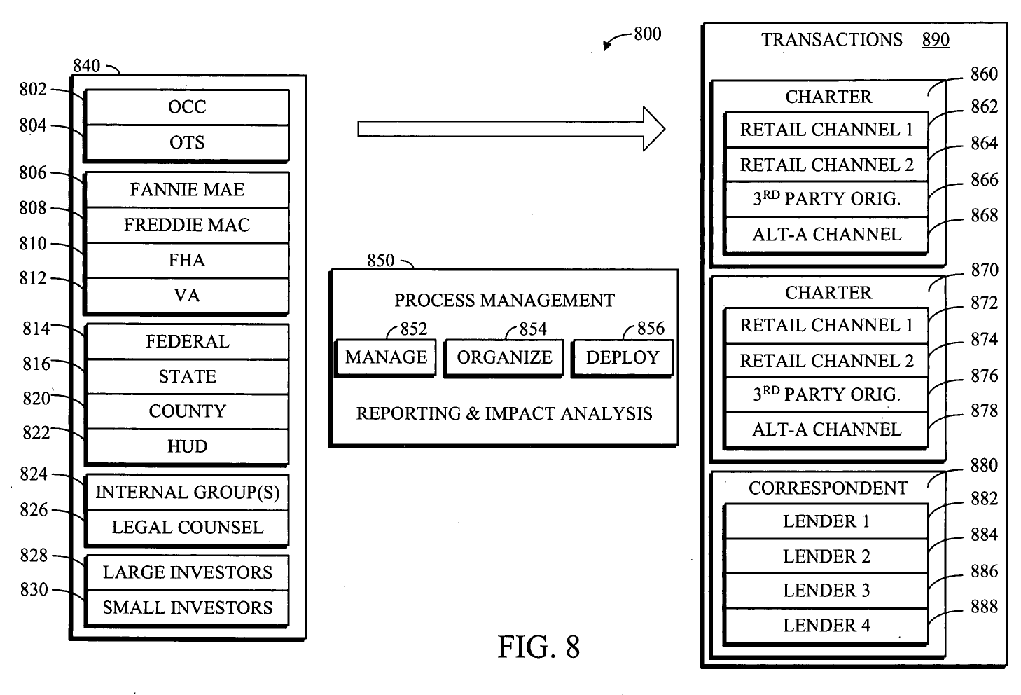

Referring now to FIG. 8, a block diagram 800 representing the relationship of various components of a process flow for implementing mortgage documents via universal document libraries in accordance with an exemplary preferred embodiment of the present invention is depicted. Input sources 840 represent the various sources for data that can be used in implementing mortgage documents while Process management mechanism 850 represents the process steps associated with universal document libraries and transactions 890 is focused on the procurement and deployment of mortgage related documents associated with the universal document libraries of the present invention.

As shown in FIG. 8, a variety of input sources 840 include the Office of Comptroller of the Currency (OCC) 802, Office of Thrift Supervision (OTS) 804, FANNIE MAE 806, FREDDIE MAC 808, FHA 810, VA 812, governmental agencies such as Federal Agencies 814, State Agencies 816, County Agencies 820, the office of Housing and Urban Development (HUD) 822, Internal Groups 824, Legal Counsel 826, Large Investors 828, and Small Investors 830. OCC 802 and OTS 804 are federal regulatory agencies that supervise and oversee federal banks and thrift institutions to insure compliance with federal law. FANNIE MAE 806, FREDDIE MAC 808, FHA 810, VA 812 are secondary investors that purchase loans after the lender has funded the original loan. These secondary investors typically pool similar mortgages together then sell the pooled mortgages as investments in the open market. Because these investors are purchasing the original loans and packaging them for the investment market, they may have additional requirements for the type of information that is gathered and managed during the initial loan process. In order to facilitate the secondary market requirements, this information is typically gathered at the time the original loan is initiated.

Federal Agencies 814, State Agencies 816, County Agencies 820, and HUD 822 represent additional institutions that develop requirements for various loan programs and documents that may require the gathering and processing of additional information from the prospective borrower.

Internal groups 824 represent different internal organizational groups within the lender that may have certain information requirements that must be addressed during the loan process. For example, the collection department may require that the borrower provide information about the nearest living relative so that this information is available during a prospective collection action, if necessary. Similarly, Legal Counsel 826 represent various legal individuals or entities that require the gathering of information for these authorized legal practitioners to use in the generation and/or evaluation of loan documents.

Large investors 828 and small investors 830 are representative of individuals or institutions that purchase or keep loans for investment purposes, typically the interest payments generated by the underlying loans. Large investors 828 may be represented by an institutional investor such as an employee retirement fund and small investors 830 may be characterized by a credit union or the like.

Each of these various input sources 840 have loan parameters that include specific directives, rules and requirements that must be satisfied in order to have their involvement in a loan program. Since very few loans can be implemented and processed without the approval of one or more of these input sources 840, it is important to include the rules and requirements of these input sources 840 in the development of the universal document libraries.

Process management mechanism 850 is a transformative process step that incorporates the management, organization, and the deployment of various loan documents in conjunction with the universal document libraries of the present invention. Process management mechanism 850 receives and incorporates the loan parameters from input sources 840 which can then be coordinated with the legal documents previously created by authorized legal practitioners for use with one or more universal document libraries. Once incorporated, the universal document libraries are available for transactional deployment to various loan origination agencies.

The Management Process 852 reflects the use of the Issue Manager 530, Rule Writer 540, and Form Mapper 510 tools from FIG. 5 as the primary mechanisms to track and maintain the content developed from input sources 840. With the wide variety of information generated by input sources 840, it is important to have a means to effectively coordinate and manage this information. The Organization Process 854 reflects the use of the Form Mapper 510 and Library Manager 520 tools of FIG. 5 to ensure that all of the changes generated from Input Sources 840 are consistently managed, applied and tacked across the various different loan programs, vendors, etc.

The Deployment process 856 reflects the use of Promotion Service 550 and Mass Update Service 560 of FIG. 5 to manage the deployment of documents in conjunction with the universal document libraries of the present invention. This includes the process of ensuring that the appropriate documents for any given loan program are available for the use of the appropriate party or entity at the appropriate time to ensure that the loan process may proceed without any unnecessary delays.

Transactions 890 illustrate the many different types of transaction and relationships that may be invoked in a series of typical loan programs. For example, Charter 860 may represent a situation where a lender generates one or more mortgages under the auspices of their national banking charter, as authorized by the federal government. Retail Channel 862 may represent one business unit in the lender organization (e.g., Home Equity) that issued loans to one or more borrowers for a specific need. Retail Channel 864 may represent a different business unit of the lender (e.g. Home Mortgage Lending) that is also authorized to issue loans. Similarly, 3^{rd} Party Originator 866 may represent one or more loans initiated by a third party for and on behalf of the lender (e.g., by a mortgage broker).

Each of these various loan origination agencies will typically have different information needs and priorities for the origination and processing of loans. However, the universal document libraries of the present invention will act as the coordinating mechanism for each different loan origination agency. Charter 870 may represent the same lender only, in this instance, acting under the direction of a state, as reflected in their state banking charger. In this instance, it is entirely possible that the lender's state charter will dictate the inclusion of more or less information for a given loan than the lender might have found necessary when issuing the loan under their federal banking charter.

Correspondent 880 is reflective of yet another loan origination source, this time a lender originating a loan and offering funding to the borrower and then immediately selling the loan to the lender offering the loan program. One example of this process would be a smaller lender reselling (or “private labeling”) the main lender's loan program. Each different correspondent 880 may work with multiple vendors and must gather and provide the appropriate information necessary to satisfy that lenders specific demands. Given the wide variety of possibilities shown in FIG. 8, it can be seen how important the present invention will be in ensuring that the various needs for all of the disparate scenarios can be quickly and easily handled.

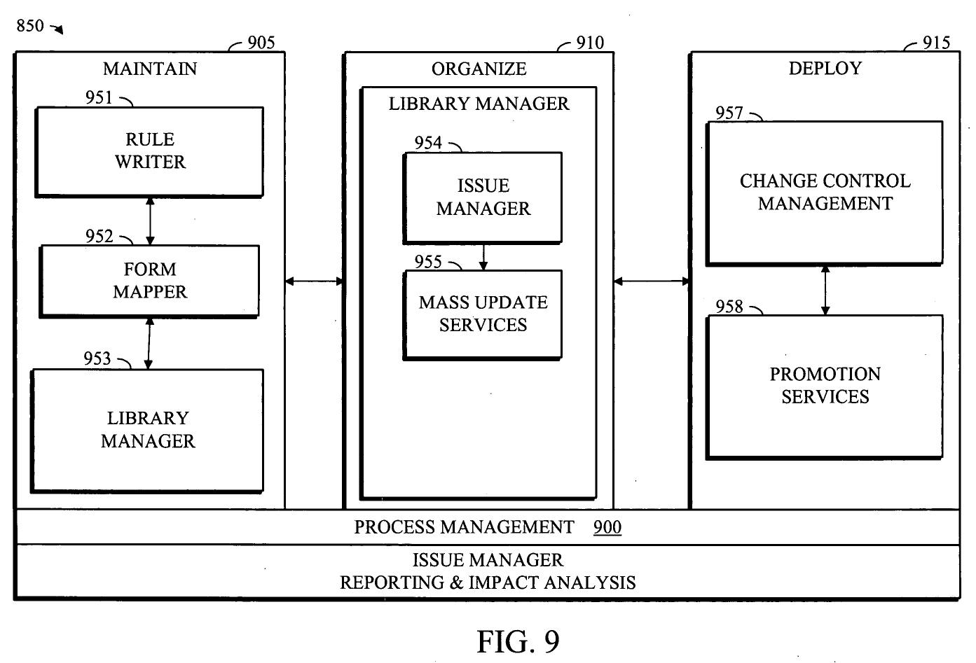

Referring now to FIG. 9, a block diagram of the process flow methodology 850 from FIG. 8 for implementing mortgage documents via universal document libraries in accordance with an preferred exemplary embodiment of the present invention is depicted. The overall process flow is managed by a process management mechanism 900. As shown in FIG. 9, once the mortgage related input has been gathered from the various input sources, it can be processed and made available in various embodiments. The mortgage related input is managed by a Maintenance Mechanism 905 which includes Rule Writer 951 which, in turn, communicates with Form Mapper 952 which, in turn, communicates with Library Manager 953. Form Mapper 952 includes a PCL conversion function, a form compare function, and a form mapper. Maintenance Mechanism 905 includes the capability to enter content for universal document libraries (forms, rules, etc.) and group the content into packages that will eventually comprise a universal document library.

The organization of the data and corresponding documents for inclusion in universal document libraries is performed by an organization mechanism 910. By deploying Issue Manager 954 and Mass Update Service 955, Organization Mechanism 910 provides the capability to track change requests, status of change requests and to then replicate the updates across the various tools and library elements.

The deployment of universal document libraries is managed by a Deployment Mechanism 915. Deployment Mechanism 915 applies the changes made in response to change requests and replicates the updates from the development environment to the testing environment and from the testing environment to the production environment.

In summary, the present invention provides broad application of a unique business process where various entities including lenders, insurance companies, title companies, mortgage brokers, attorneys and the like are all benefited and served by the methods and integrated processes comprehended by the various preferred embodiments of the present invention.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. A method comprising the steps of:
implementing at least one form to be used in offering a mortgage;
incorporating said at least one form into at least one universal document library;
promoting said at least one universal document library for testing;
testing said at least one universal document library to achieve a result;
promoting said at least one universal document library for production use if said result is positive; and
procuring a plurality of mortgage related forms from said at least one universal document library.

2. The method of claim 1 wherein said at least one universal document library comprises at least one of:
a universal compliance library;
a universal maintained library;
a universal custom library; and
a universal standard library.

3. The method of claim 1 wherein said at least one universal document library comprises a universal standard library electronically linked to a universal compliance library, said universal compliance library comprising a plurality of mortgage related forms and wherein said at least one form comprises a subset of said plurality of mortgage related forms.

4. The method of claim 3 further comprising the step of automatically updated said at least one form by updating at least one of said plurality of mortgage related forms in said universal compliance library.

5. The method of claim 1 wherein said step of implementing at least one form to be used in offering a mortgage comprises the steps of:
incorporating a plurality of form fields within said at least one form, said plurality of form fields being configured to populate said at least one form with a plurality of data;
selecting at least one of mask from a plurality of masks, said at least one mask being configured to control the display format of at least one of said plurality of form fields;
selecting at least one overlay from a plurality of overlays, said at least one overlay being configured to control the placement of said plurality of form fields on said at least one form; and
incorporating a plurality of rules within said at least one form, said plurality of rules being configured to determine whether or not said at least one form should be included in at least one collection of mortgage related documents.

6. The method of claim 1 wherein said step of incorporating said at least one form into said at least one universal document library comprises the step of copying said at least one form from said one universal document library into another universal document library.

7. The method of claim 1 wherein said step of promoting said at least one universal document library for testing comprises the step of moving said at least one universal document library to a testing environment.

8. The method of claim 1 wherein said step of testing said at least one universal document library to achieve a result comprises the step of repeatedly using said at least one universal document library to procure a plurality of mortgage related documents and verifying the accuracy of both the number and type of said plurality of documents as well as the contents of said plurality of documents.

9. The method of claim 1 wherein said step of promoting said at least one universal document library for production use if said result is positive comprises the step of making said at least one universal document library available for the procurement of a plurality of mortgage related documents via the Internet.

10. The method of claim 1 wherein said step of procuring a plurality of mortgage related forms from said at least one universal document library comprises the steps of:
procuring a first set of mortgage related forms from said at least one universal document library, said first set of mortgage related forms being selected to implement a first mortgage loan program; and
procuring a second set of mortgage related forms from said at least one universal document library, said second set of mortgage related forms being selected to implement a second mortgage loan program wherein said first set of mortgage related forms and said second set of mortgage related forms are substantially different.

11. An apparatus comprising:
at least one processor;
a memory coupled to said at least one processor;
at least one universal document library residing in said memory; and
at least one tool residing in said memory, said at least one tool comprising at least one of:
a form mapper tool, said form mapper tool providing an interface for mapping at least one form field to a form;
a library manager residing in said memory, said library manager being configured to incorporate at least one form into said at least one universal document library;
a rule writer, said rule writer being configured to create, track, update, and maintain a plurality of rules that are used in conjunction with at least one document package and at least one document collection; and
an issue manager, said issue manager being configured to track at least one issue, said at least one issue comprising an identifier, a name, and a description.

12. The apparatus of claim 11 wherein said at least one tool further comprises:
a promotion service residing in said memory; and
a mass update service residing in said memory.

13. The apparatus of claim 11 wherein said universal document library further comprises:
at least one form; and
at least one rule, said at least one rule comprising at least one of:
a mask, said mask being configured to format data on said at least one form;
a form field, said form field being configured to determine which data to display on said at least one form; and
a qualification rule, said qualification rule being configured to determine whether or not to include said at least one form in at least one loan package.

14. The apparatus of claim 11 wherein said at least one universal document library comprises:
at least one universal compliance library, said at least one universal compliance library containing a plurality of forms; and
at least one universal standard library linked to said at least one universal compliance library, said at least one universal standard library containing a subset of said plurality of forms.

15. The apparatus of claim 11 further comprising:
a web portal application residing in said memory;
a fax server residing in said memory;
a web server residing in said memory;
a security mechanism residing in said memory; and
an e-mail server residing in said memory.

16. The apparatus of claim 11 further comprising a network coupled to said apparatus and being configured to communicate with said apparatus.

17. The apparatus of claim 16 further comprising a computer coupled to said network, said computer accessing said at least one universal library to procure a plurality of mortgage related forms.

18. The apparatus of claim 11 wherein said at least one universal library comprises:
at least one universal compliance library, said at least one universal compliance library containing a plurality of forms; and
at least one universal standard library linked to said at least one universal compliance library, said at least one universal standard library containing a subset of said plurality of forms wherein each of said subset of said plurality of forms comprises:
at least one rule, said at least one rule comprising at least one of:
a mask, said mask being configured to format data on said at least one form;
a form field, said form field being configured to determine which data to display on said at least one form; and
a qualification rule, said qualification rule being configured to determine whether or not to include said at least one form in at least one loan package.

19. A program product comprising:
a plurality of tools, said plurality of tools comprising:
a form mapper tool, said form mapper tool being configured to provide an interface for mapping at least one form field to a form;
a library manager, said library manager being configured to incorporate at least one form into at least one universal document library;
a rule writer, said rule writer being configured to create, track, update, and maintain a plurality of rules that are used in conjunction with at least one document package and at least one document collection; and
an issue manager, said issue manager being configured to track at least one issue, said at least one issue comprising an identifier, a name, and a description; and
a signal bearing media bearing said plurality of tools.

20. The program product of claim 19 wherein said signal bearing media comprises recordable media.

21. The program product of claim 19 wherein said signal bearing media comprises transmission media.

22. The program product of claim 19 wherein said universal document library is configured to procure at least one mortgage related document via the Internet.
